(19) United States
(12) Patent Application Publication
(10) Pub. No.: US 2024/0233001 A9
(43) Pub. Date: Jul. 11, 2024

(54) INFORMATION PROCESSING APPARATUS

(71) Applicant: TOYOTA JIDOSHA KABUSHIKI KAISHA, Toyota-shi Aichi-ken (JP)

(72) Inventors: Yoshito ISHIJIMA, Nagoya-shi Aichi-ken (JP); Yosuke NITTA, Kashiwa-shi Chiba-ken (JP); Yu HAMADA, Nagoya-shi Aichi-ken (JP)

(73) Assignee: TOYOTA JIDOSHA KABUSHIKI KAISHA, Toyota-shi Aichi-ken (JP)

(21) Appl. No.: 18/379,693

(22) Filed: Oct. 13, 2023

(30) Foreign Application Priority Data
Oct. 19, 2022 (JP) 2022-167746

(51) Int. Cl. G06Q 30/0645

(52) U.S. Cl. CPC G06Q 30/0645

(57) ABSTRACT

An Information processing apparatus accepts orders for a vehicle component to be retrofitted to the vehicle subject to the lease agreement. The controller of the information processing apparatus acquires information on the vehicle lease agreement by a user. The controller also accepts the designation of the vehicle component from the user. In addition, the controller presents the user with a payment method for the vehicle component based on the status of payment in the lease agreement.

### CROSS REFERENCE TO THE RELATED APPLICATION

This application claims the benefit of Japanese Patent Application No. 2022-167746, filed on Oct. 19, 2022, which is hereby incorporated by reference herein in its entirety.

### BACKGROUND

### Technical Field

The present disclosure relates to an information processing apparatus.

### Description of the Related Art

Conventionally, there is an application system for purchasing a car by installment payment (see, for example, Patent Literature 1).

### CITATION LIST

### Patent Literature

Patent Literature 1: Japanese Patent Laid-Open No. 2021-184156

### SUMMARY

The purpose of the present disclosure is to provide an information processing apparatus that enables the determination of an appropriate sales method for parts to be retrofitted to a vehicle subject to a lease agreement.

An information processing apparatus according to the present disclosure may comprise a controller configured to execute: obtaining information on the lease agreement of the first vehicle by the first user, accepting the designation of a first vehicle component that the first user wishes to purchase, wherein the first vehicle component is a vehicle component that can be retrofitted to the first vehicle, and transmitting information including a payment method for the first vehicle component determined based on the payment status in the lease agreement to the terminal of the first user.

Aspects of the present disclosure may include at least one of an information processing method, an information processing system, a program, and a recording medium in which the program is recorded, having the same characteristics as the information processing apparatus.

According to the present disclosure, it is possible to determine an appropriate method of selling parts to be retrofitted to the vehicle subject to the lease agreement.

### BRIEF DESCRIPTION OF THE DRAWINGS

FIG. 1 is a diagram showing a configuration example of an information processing system according to an embodiment.

FIG. 2A is a diagram showing a configuration example of a server device that can operate as a first server or a second server.

FIG. 2B is a diagram showing a configuration example a terminal.

FIG. 3A is a diagram showing an example of a data structure of a customer management database.

FIG. 3B is a diagram showing an example of a data structure of a lease management database.

FIG. 4 is a flowchart showing a processing example in the first server.

FIG. 5A is a flowchart showing a processing example in the second server.

FIG. 5B is a flowchart showing a processing example in a terminal.

### DESCRIPTION OF THE EMBODIMENTS

The information processing apparatus according to the embodiment may be an information processing apparatus that accepts orders for first vehicle components that are retrofitted to the first vehicle with which the first user has a lease agreement. The information processing apparatus may have a controller that executes the following.
The controller acquires information on the lease agreement of the first vehicle by the first user.
The controller accepts the designation of the first vehicle component from the first user.
The controller presents a payment method of the first vehicle component to the first user based on the payment status in the lease agreement.

The first vehicle component may be any type of part that can be retrofitted to the first vehicle subject to the lease agreement. The first vehicle component includes parts that upgrade the grade of the first vehicle (so-called upgrade parts), dress-up parts, and the like. Further, the parts included in the first vehicle component do not necessarily have to be hardware components (hardware products), and the first vehicle component may be software components (software products). Installation and updating of software components (programs) also fall under “retrofitting”.

The acquisition of information according to the lease agreement can include receiving the information, reading from the storage medium, and inputting information to the information processing apparatus. The designation of the first vehicle component can be made, for example, by specifying the name or identification information of the first vehicle component. Presentation of the payment method includes sending information indicating the payment method and displaying information indicating the payment method.

Hereinafter, the information processing apparatus according to the embodiment will be described with reference to the drawings. The configuration of the embodiment is exemplary, and the configuration according to the present disclosure is not limited to the configuration of the embodiment.

### <Information Processing System Configuration>

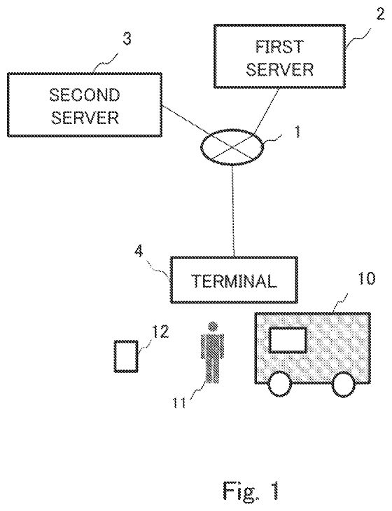

FIG. 1 indicates an example of an information processing system according to the embodiment. In FIG. 1, the information processing system includes a network 1, a first server 2, a second server 3, and a terminal 4. The first server 2, the second server 3, and the terminal 4 are each connected to the network 1.

The network 1 is a public communication network such as the Internet, for example. As the network 1, a WAN (Wide Area Network) or other communication network may be employed. The network 1 may include a cellular network such as LTE (Long Term Evolution), 5G, or a wireless network (wireless path) such as a wireless LAN (Local Area Network: including Wi-Fi) and BLE.

The user 11 is a user who has a lease agreement for the vehicle 10. Terminal 4 is a terminal device used by the user 11. The terminal 4 is, for example, a smartphone. The terminal 4 may be a communication terminal other than a smartphone. The terminal 4 may be a mobile terminal or a fixed terminal. Terminal 4 may be wirelessly connected to the network 1. Terminal 4 may be connected to network 1 by wire.

The vehicle 10 is an example of the “first vehicle” according to the present disclosure. User 11 is an example of a “first user” according to the present disclosure.

The first server 2 manages a website for online sales of retrofit parts of the vehicle 10. The user 11 can use terminal 4 to access a website that sells retrofit parts for the vehicle 10 online. The first server 2 transmits information requested from the terminal 4 to the terminal 4 in response to the access of the terminal 4. For example, when the user 11 purchases the retrofit part 12 (hereinafter simply referred to as “part 12”) of the vehicle 10, the first server 2 receives a purchase request message of the part 12 transmitted from the terminal 4 via the network 1. The purchase request includes the name or identification information of the part 12. The part 12 is an example of a “first vehicle component” according to the present disclosure.

The second server 3 is a server that manages the payment status of the user 11 for the fee (lease fee) related to the lease agreement of the vehicle 10. The second server 3 stores a history related to the payment of the lease fee of the vehicle 10. When the second server 3 receives an inquiry message from the first server 2, the second server 3 transmits the history information corresponding to the inquiry to the first server 2.

Note that the first server 2 and the second server 3 may be server machines independent of each other as indicated in FIG. 1 In this case, the first server 2 and the second server 3 are connected to the network. Alternatively, one server machine may operate as a first server 2 and a second server 3. In this case, the communication between the first server 2 and the second server 3 is internal communication within the server machine. Alternatively, a plurality of server machines may operate as the first server 2 and the second server 3 by distributed processing.

### <Configuration of a Server>

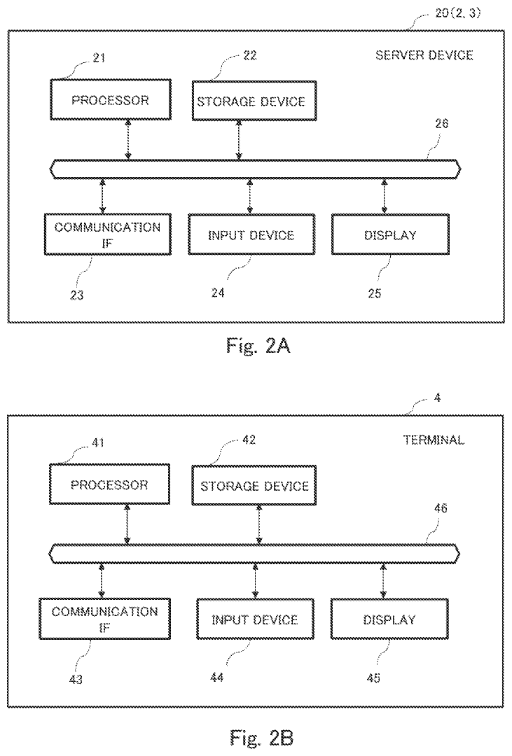

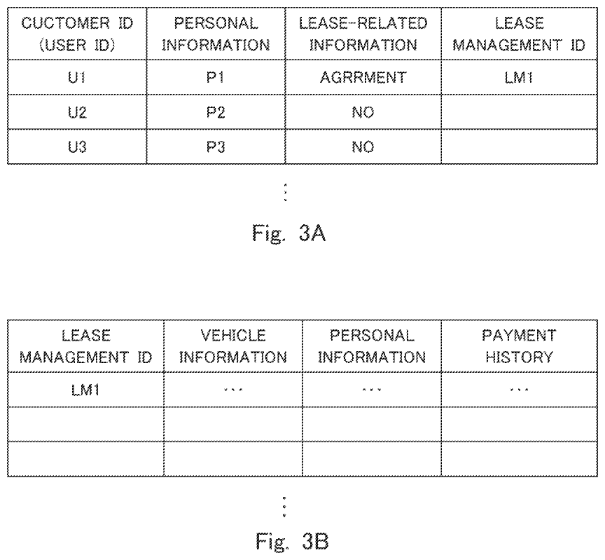

FIG. 2A is a diagram illustrating a configuration example of a server device (server machine) 20 that can operate as a first server 2 or a second server 3. The server device 20 can be configured using an information processing apparatus (computer) such as a personal computer (PC), a workstation (WS), or a server machine.

The server device 20 can communicate with the terminal 4 via the network 1 by the communication function. The server device 20 may be wired to the network 1 or may be connected wirelessly. The server device 20 may be configured by one information processing apparatus or may be configured in a set (cloud) of two or more information processing apparatuses. The server device 20 may be a fixed terminal or a mobile terminal.

The server device 20 includes a processor 21 as a processing unit or a control controller), a storage device 22, a communication interface 23 (communication IF 23), an input device 24, and a display 25. The devices in the server device 20 are connected to each other via a path 26.

The storage device 22 includes a main memory and an auxiliary storage device. The main memory is used as at least one of a program and data storage area, a program expansion area, a program work area, and a communication data buffer area. The main memory is composed of RAM (Random Access Memory) or a combination of RAM and ROM (Read Only Memory). The auxiliary storage device is used as a storage area for data and programs. A non-volatile storage medium is applied to the auxiliary storage device. Non-volatile storage media include, for example, hard disks, solid state drives (SSDs), flash memory, or EEPROM (Electrically Erasable Programmable Read-Only Memory). The storage device 22 can also include a drive device for the disk recording medium.

The communication IF 23 is a circuit that performs communication processing. For example, the communication IF 23 is a network interface card (NIC). Further, the communication IF 23 may be a wireless communication circuit that performs wireless communication (LTE, 5G, wireless LAN (Wi-Fi), BLE, etc.). Further, the communication IF 23 may be a combination of a circuit that performs wired communication processing and a wireless communication circuit.

The input device 24 is used for inputting information. The input device 24 includes a key, a button, a pointing device, a touch panel, or the like. The display 25 displays information and data. The display 25 is, for example, a liquid crystal display.

The processor 21 performs various processes by executing various programs stored in the storage device 22.

FIG. 2B is a diagram indicating a configuration example of the terminal 4. The terminal 4 includes a processor 41, a storage device 42, a communication interface 43 (communication IF 43), an input device 44, and a display 45. The devices in terminal 4 are connected to each other via a path 46. The processor 41, the storage device 42, the communication IF 43, the input device 44, and the display 45 can be used the same as the processor 21, the storage device 22, the communication IF 23, the input device 24, and the display 25 in the server device 20. Therefore, these descriptions are omitted.

Processor 21 and processor 41 are, for example, a Central Processing Unit (CPU). CPU is also known as Microprocessor Unit (MPU). The processor 21 may be a single processor configuration or a multiprocessor configuration. Further, a single physical CPU connected by a single socket may have a multi-core configuration. The processor 21 and processor 41 may include arithmetic units having various circuit configurations such as a digital signal processor (DSP) or a graphics processing unit (GPU). Further, the processor 21 and the processor 41 may have a configuration that cooperates with at least one of an integrated circuit (IC), other digital circuit, analog circuit, or the like. The integrated circuit may include an LSI, an Application Specific Integrated Circuit (ASIC), and a programmable logic device (PLD). The PLD may be, for example, a Field-Programmable Gate Array (FPGA). The processor 21 and processor 41 may be referred to, for example, a microcontroller (MCU), an SoC (System-on-a-chip), a system LSI, or a chipset.

### <Configuration of Tables>

FIG. 3A indicates an example of a data structure of a customer management database (customer managed DB) stored in the storage device 22 of the first server 2. The customer management DB has a record for each customer ID (user ID). The records stored in the customer management DB include personal information, lease-related information, and lease management ID associated with the customer ID.

The customer ID (user ID) is an identification information (identifier) of a customer (user) of a retrofit parts sales site. Personal information may include name, address, and contact information of a customer of a sales website such as user 11. The contact information may be a telephone number or an email address. The personal information may also include the user's credit card information and the like.

Lease-related information includes information indicating whether or not a vehicle is lease agreement. The lease-related information can further include vehicle information of the leased vehicle and information indicating parts compatible with the leased vehicle. The vehicle information can include, for example, vehicle identification information (vehicle ID). The vehicle information can further include information that identifies the leased vehicle, such as the vehicle model and model of the vehicle to be leased. The vehicle information can further include information indicating the attributes possessed by the leased vehicle. The information indicating the part includes the name or identification information (part ID) of the part. The lease management ID is identification information of the lease agreement related to the vehicle to be leased.

FIG. 3B is an example of a data structure of a lease management database (lease management DB) stored in the storage device 22 of the second server 3. The lease management DB has a record for each lease agreement. Records stored in the lease management DB include vehicle information, personal information, and payment history (hereinafter simply referred to as “history”). In the record, the vehicle information, the personal information, and the history are associated with the lease management ID.

The vehicle information and the personal information are the same as information stored in the customer management DB. The history is a list of records related to the payment of lease fees. Records included in the history include the date of deposit (date and time of payment), payment amount, payment deadline, and whether there is a delay in payment.

### <Example of Processing>

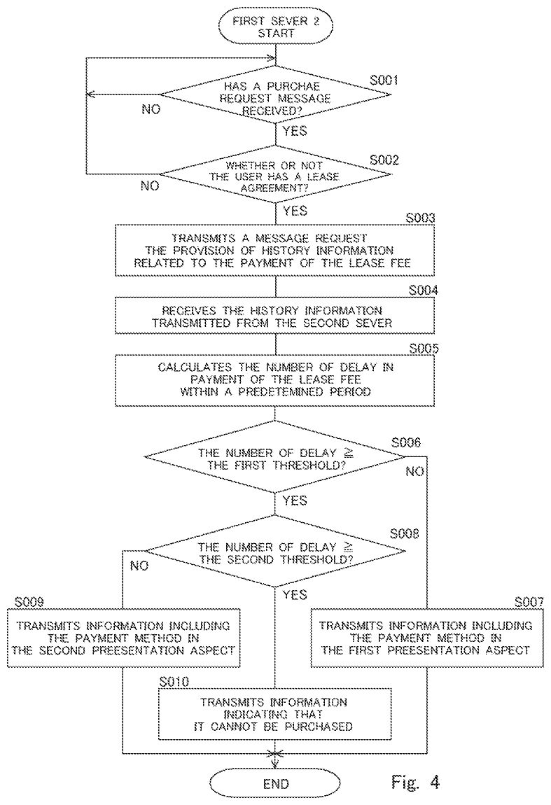

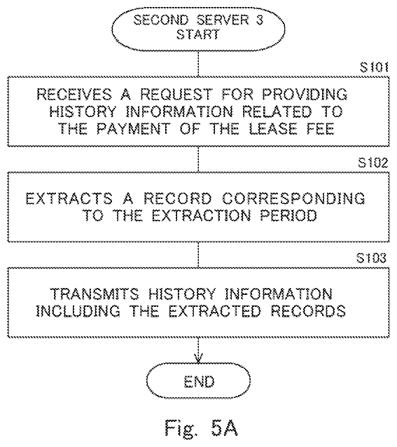

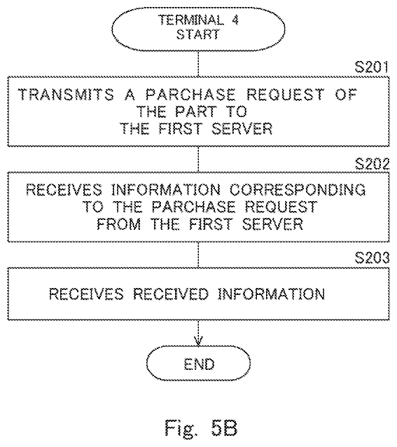

FIG. 4 is a flowchart indicating a processing example in the first server 2. FIG. 5A is a flowchart indicating a processing example in the second server 3. FIG. 5B is a flowchart indicating a processing example in the terminal 4. The process indicated in FIG. 4 and FIG. 5A is performed by the processor 21 executing the program. The process indicated in FIG. 5B is performed by the processor 41 executing the program. Here, as an example, a case where a user 11 who has concluded a lease agreement for the vehicle 10 transmits a purchase request for the part 12 as a retrofit part of the vehicle 10 using the terminal 4 will be described.

The process indicated in FIG. 4 is performed by the processor 21 of the first server 2 as an example. In step S001, the first server 2 waits for receiving a message of a purchase request (order) for the part 12 from the terminal 4. In step S001, when it is determined that a purchase request message has been received, the processor 21 is in a state where the order of the part 12 has been received. In this case, the process proceeds to step S002.

In step S002, the processor 21 determines whether or not the user 11 has a lease agreement. For example, the processor 21 refers to the customer management DB and extracts a record matching the customer ID of the user 11 included in the purchase request. The processor 21 refers to the lease-related information in the extracted record and determines whether there is information indicating the existence of a lease agreement for the lease of the vehicle 10. At this time, if it is determined that there is information indicating the existence of a lease agreement, the process proceeds to step S003. If it is not determined that there is information indicating the existence of a lease agreement, the process returns to step S001. The process returns to step S001.

However, the determination in step S002 may be performed as follows. That is, in addition to determining whether there is information indicating the existence of a lease agreement for the lease of vehicle 10, processor 21 may determine whether the part ID of the retrofit part (part 12) desired for purchase included in the purchase request matches the information indicating the part (part ID) in the lease-related information. Then, when it is determined that the part ID of the part 12 matches the part ID in the lease-related information and that there is information indicating the existence of a lease agreement, the process may proceed to step S003. Thus, when there is a lease agreement for the lease of the vehicle 10 and the part 12 is a retrofit part of the vehicle 10 that is the vehicle to be leased, the process may proceed to step S003.

In step S003, the first server 2 transmits a message request the provision of history information related to the payment of the lease fee to the second server 3. The provision request may include information that specifies the extraction period (predetermined period: beginning and cycle of the period) of the record to be extracted from the history. The length of the extraction period can be set appropriately. The entire period can also be specified as the extraction period. Further, when the information specifying the extraction period is not included in the provision request, it may be determined that the extraction period is the entire period or a predetermined period in the second server 3.

In step S004, the first server 2 receives the history information transmitted from the second server 3. In step S005, the processor 21 calculates the number of delay in payment of the lease fee within a predetermined period using the history information. The history information includes one or more records that match the specified extraction period. The processor 21 calculates the number of records whose deposit date is later than the payment deadline as the number of delays.

In step S006, the processor 21 determines whether or not the number of delay in payment of the lease fee is greater than or equal to the first threshold. The first threshold is 1. If it is determined that the number of delays is greater than or equal to the first threshold, the process proceeds to step S008. If it is not determined that the number of delays is greater than or equal to the first threshold, the process proceeds to step S007. However, a value greater than 1 may be set as the first threshold.

In step S007, a process is performed when there is no delay in payment of the lease fee or when the number of delay in payment is less than the first threshold. In this process, the processor 21 generates information including a payment method for the part 12 in the first presentation aspect. In the first presentation aspect, lump sum payment and installment payment are included as payment options for the price of the part 12. Then, the first server 2 transmits information including the payment method of the part 12 in the first presentation aspect as a message (response message to the purchase request) to the terminal 4.

In step S008, the processor 21 determines whether or not the number of delay in payment of the lease fee is greater than or equal to the second threshold greater than the first threshold. If it is not determined that the number of delays is greater than or equal to the second threshold, the process proceeds to step S009. If it is determined that the number of delays is greater than or equal to the second threshold, the process proceeds to step S010.

In step S009, a process performed when the number of delays is greater than or equal to the first threshold and less than the second threshold is executed. In this process, processor 21 generates information including payment methods for part 12 in the second presentation aspect. In the second presentation aspect, only lump sum payment is included as a payment method for the price of the part 12. Then, the first server 2 transmits information including the payment method of the part 12 in the second presentation aspect as a message (response message to the purchase request) to the terminal 4.

In step S010, a process performed when the number of delays is greater than or equal to the second threshold is executed. In this process, the processor 21 generates information refusing to sell the part 12 to the user 11 (information indicating that it cannot be purchased). Then, the first server 2 transmits information indicating that it cannot be purchased as a message (response message to the purchase request) to the terminal 4. Thus, if there is a delay in payment of the lease fee, the payment of the part 12 is limited to a lump sum payment only, or the sale of the part 12 is refused.

In step S101 in FIG. 5A, the second server 3 receives a request from the first server 2 for providing history information related to the payment of the lease fee. The provision request contains information indicating the lease management ID and the extraction period of the record to be extracted from the history.

In step S102, the processor 21 of the second server 3 refers to the lease management DB and extracts a record that matches the lease management ID. The processor 21 refers to the payment history in the record and extracts a record corresponding to the extraction period.

In step S103, the second server 3 transmits history information including the records extracted in step S102 to the first server 2.

When the user 11 inputs information indicating the purchase desire of the part 12 to the terminal 4 by operating the input device 24, and further executes a transmission operation for the purchase request of the part 12, the process shown in FIG. 5B is performed. In step S201 in FIG. 5B, the terminal 4 transmits a purchase request message to the first server 2.

In step S202, the terminal 4 receives information (response message) corresponding to the purchase request from the first server 2. In step S203, the processor 41 of terminal 4 displays information in the received response message on the display 45.

Thereby, if there is no delay in the payment of the lease fee of the vehicle 10, or if the number of delays is less than the first threshold, the processor 41 can display (present) a lump sum payment and an installment payment on the display 45 as a payment method option for the purchase price of the part 12. Further, when the number of delay in payment the lease fee of the vehicle 10 is greater than or equal to the first threshold and less than the second threshold, the processor 41 displays (presents) only the lump sum payment on the display 45 as a payment method for the purchase price of the part 12. Further, when the number of delays is greater than or equal to the second threshold, the processor 41 can display (present) information indicating that the parts 12 cannot be purchased on the display 45.

Note that the process of step S005 shown in FIG. 5 may be executed in the first server 2. Then, the number of delay in payment the lease fee of the vehicle 10 within a predetermined period may be stored in advance in the corresponding record stored in the lease management DB. In this case, the second server 3 may read the number of delays stored in the record corresponding to the provision request from the lease management DB in response to the receipt of the request for providing history information. Then, the second server 3 may transmit the number of delays read to the first server 2 as history information. Further, when the second server 3 receives a request for providing history information, a process corresponding to step S005 may be performed. Then, the second server 3 may transmit the calculated delay number to the first server 2 as history information.

### Effect of Embodiment

In the information processing system according to the embodiment, the first server 2 (information processing apparatus) receives an order for a part 12 (first vehicle component) to be retrofitted to the vehicle 10 (first vehicle) with which the user 11 (first user) has a lease contract.

The processor 21 (controller) included in the first server 2 can execute a process of acquiring information on the lease contract of the vehicle 10 by the user 11 from the terminal 4. Further, the processor 21 can execute a process of receiving the designation of the part 12 from the user 11. Further, the processor 21 can execute a process of presenting a payment method of the part 12 to the user 11 based on the payment status in the lease contract.

The processor 21 (controller) can present a lump sum payment and an installment payment to the user 11 as payment options for the part 12 when there is no delay in the payment status in the lease agreement. Further, when there is a delay in the payment status in the lease agreement, the processor 21 (controller) can present only a lump sum payment to the first user as a payment method for the part 12. Thus, depending on the payment situation in the lease agreement, the sales method of the part 12 presented to the user 11 can be determined.

The payment status may include at least one of a first situation in which there is a delay in payment of lease fees less than a predetermined number of times within a predetermined period and a second situation in which there is a delay in payment of lease fees more than a predetermined number within a predetermined period. The processor 21 (controller) may present only a lump sum payment to the user 11 as a payment method for the part 12 when the payment status in the lease agreement is in the first situation where there is a delay in payment less than a predetermined number of times within a predetermined period. The processor 21 may refuse to sell the part 12 to the user 11 when the payment status is in a second situation where there is a delay in payment more than a predetermined number of times within a predetermined period.

The above embodiments and modifications are just examples, and the present disclosure may be appropriately modified and implemented within the scope of not departing from the gist thereof. In addition, the processes and structure described in the present disclosure can be freely combined and implemented as long as no technical contradiction occurs.

Furthermore, a process that is described to be performed by one apparatus may be shared and performed by a plurality of apparatuses. Processes described to be performed by different apparatuses may be performed by one apparatus. Which function is to be implemented by which hardware configuration (server configuration) in a computer system may be flexibly changed.

The present disclosure may also be implemented by supplying computer programs for implementing the functions described in the embodiments described above to a computer, and by one or more processors of the computer reading out and executing the programs. Such computer programs may be provided to the computer by a non-transitory computer-readable storage medium that can be connected to a system bus of the computer or may be provided to the computer through a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), and any type of medium suitable for storing electronic instructions, such as read-only memories (ROMs), random access memories (RAMs), EPROMs, EEPROMs, magnetic cards, flash memories, or optical cards.

What is claimed is:

1. An information processing apparatus comprising a controller configured to execute:
obtaining information on the lease agreement of the first vehicle by the first user,
accepting the designation of a first vehicle component that the first user wishes to purchase, wherein the first vehicle component is a vehicle component that can be retrofitted to the first vehicle, and
transmitting information including a payment method for the first vehicle component determined based on the payment status in the lease agreement to the terminal of the first user.

2. The information processing apparatus according to claim 1, wherein
in the payment status in the lease agreement, when there is no delay in payment or the delay in payment is less than a predetermined number of times, the controller transmits information indicating that the payment method option includes lump sum payment and installment payment.

3. The information processing apparatus according to claim 1, wherein
in the payment status in the lease agreement, when there is delay in payment, the controller transmits information indicating that the payment method is only a lump sum payment.

4. The information processing apparatus according to claim 3, wherein
the payment status is a first situation in which there is the delay in payment less than a predetermined number of times within a predetermined period, or a second situation in which there is a delay in payment more than a predetermined number of times within the predetermined period.

5. The information processing apparatus according to claim 3, wherein
when the payment status is in a first situation in which there is a delay in payment of less than a predetermined number of times within a predetermined period, the controller transmits information indicating that the payment method is only a lump sum payment to the terminal of the first user, and
when the payment status is in a second situation in which there is a delay in payment of more than the predetermined number of times within the predetermined period, the controller transmits information indicating that the sale of the first vehicle component to the first user is refused to the terminal of the first user.
